(19) United States
(12) Patent Application Publication
(10) Pub. No.: US 2025/0044170 A1
(43) Pub. Date: Feb. 6, 2025

(54) STRAIN SENSOR

(71) Applicant: Murata Manufacturing Co., Ltd., Nagaokakyo-shi (JP)

(72) Inventors: Takayoshi OBATA, Nagaokakyo-shi (JP); Tomoki OUCHI, Nagaokakyo-shi (JP); Toru YABE, Nagaokakyo-shi (JP); Koji TANAKA, Nagaokakyo-shi (JP)

(21) Appl. No.: 18/924,103

(22) Filed: Oct. 23, 2024

Related U.S. Application Data
(63) Continuation of application No. PCT/JP2023/006387, filed on Feb. 22, 2023.

(30) Foreign Application Priority Data
Jun. 27, 2022 (JP) 2022-102981

(51) Int. Cl. G01L 1/22

(52) U.S. Cl. CPC G01L 1/22

(57) ABSTRACT

A device may include a substrate which is configured to be stretchable and contractible and includes a major surface. A device may include a first wire and a second wire which are disposed on or in the major surface. A device may include in a plan view from a normal direction of the major surface, the substrate includes a sensing region which is configured to be stretchable and contractible in a first direction, and a first region and a second region that face each other in the first direction across the sensing region, the first wire and the second wire extend over the first region, the sensing region, and the second region; and the first wire and the second wire are electrically isolated from each other and are arranged in the sensing region at a distance from each other in a second direction that is orthogonal to the first direction.

### CROSS REFERENCE TO RELATED APPLICATIONS

This application is a continuation of International Application No. PCT/JP2023/006387, filed Feb. 22, 2023, which claims priority to Japanese Patent Application No. 2022-102981, filed Jun. 27, 2022, the contents of each of which are hereby incorporated by reference in their entirety.

### TECHNICAL FIELD

The present disclosure is directed to a strain sensor.

### BACKGROUND

In recent years, strain sensors have been used for detecting and controlling the movements of bodies and robots. For example, International Publication No. 2020/166122 (the “'122 Publication”) discloses a strain sensor that is attached to, for example, a human body and can detect the movements of joints or cartilage.

The strain sensor disclosed in the '122 Publication includes a sensor sheet including a substrate that can stretch and contract and a detection conductor (hereafter referred to as a “detection wire” or simply as a “wire”) that is provided on the substrate and formed of a material whose resistance value greatly varies in response to being stretched or contracted. The detection wire stretches and contracts in a predetermined direction in response to the strain of a target object and detects the strain in the stretching and contracting direction.

The detection accuracy of the strain sensor the '122 Publication tends to decrease as a result of deformation of portions of the sensor sheet that are located at the ends of a sensing part.

### SUMMARY OF THE INVENTION

An object of the present disclosure is to solve the above-described problem and to provide a strain sensor that more accurately detects the strain of a measurement region of a target object.

To achieve the above object, a strain sensor according to an aspect of the present disclosure includes a substrate that is stretchable and contractible and includes a major surface, a first wire that is disposed on or in the major surface and extends in a first direction, and a second wire that is disposed on or in the major surface and extends in the first direction. In plan view from the normal direction of the major surface, the substrate includes a sensing region that is stretchable and contractible in the first direction and a first region and a second region that face each other in the first direction across the sensing region. Each of the first wire and the second wire extends over the first region, the sensing region, and the second region. The first wire and the second wire are electrically isolated from each other and are arranged in the sensing region at a distance from each other in a second direction that is orthogonal to the first direction. At least one of the first wire and the second wire includes a first dense wire part that is disposed in the first region and in which the corresponding one of the first wire and the second wire is laid out more densely than in the sensing region, and at least one of the first wire and the second wire includes a second dense wire part that is disposed in the second region and in which the corresponding one of the first wire and the second wire is laid out more densely than in the sensing region.

In some aspects, the techniques described herein relate to a strain sensor including: a substrate which is configured to be stretchable and contractible and includes a major surface; and a first wire and a second wire which are disposed on or in the major surface, wherein in a plan view from a normal direction of the major surface, the substrate includes a sensing region which is configured to be stretchable and contractible in a first direction, and a first region and a second region that face each other in the first direction across the sensing region; wherein the first wire and the second wire extend over the first region, the sensing region, and the second region; and wherein the first wire and the second wire are electrically isolated from each other and are arranged in the sensing region at a distance from each other in a second direction that is orthogonal to the first direction.

In some aspects, the techniques described herein relate to a strain sensor including: a substrate which is configured to be stretchable and contractible and includes a major surface; and a first wire and a second wire which are disposed on or in the major surface, wherein in plan view from a normal direction of the major surface, the substrate includes a sensing region which is configured to be stretchable and contractible in a first direction, and a first region and a second region that face each other in the first direction across the sensing region; wherein at least one of the first wire and the second wire includes a first dense wire part that is disposed in the first region and in which a corresponding one of the first wire and the second wire is laid out more densely than in the sensing region; wherein at least one of the first wire and the second wire includes a second dense wire part that is disposed in the second region and in which a corresponding one of the first wire and the second wire is laid out more densely than in the sensing region.

A strain sensor according to the present disclosure can more accurately detect the strain of a measurement region of a target object.

### BRIEF DESCRIPTION OF DRAWINGS

In the descriptions that follow, like parts are marked throughout the specification and drawings with the same numerals, respectively. The drawings are not necessarily drawn to scale and certain drawings may be illustrated in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is a plan view of a strain sensor in accordance with aspects of the present disclosure;

FIG. 2 is an enlarged plan view of a part of the strain sensor of FIG. 1 in accordance with aspects of the present disclosure;

FIG. 3 is an enlarged plan view for describing the wire density in the strain sensor of FIG. 1 in accordance with aspects of the present disclosure;

FIG. 4 is an enlarged plan view of a dense wire part in the strain sensor of FIG. 1 in accordance with aspects of the present disclosure;

FIG. 5A is a plan view for describing an example of measurement using the strain sensor of FIG. 1 in accordance with aspects of the present disclosure;

FIG. 5B is a diagram illustrating an example of a measurement result obtained using the strain sensor of FIG. 1 in accordance with aspects of the present disclosure;

FIG. 5C is a plan view for describing an example of measurement performed when the distance between wires changes in accordance with aspects of the present disclosure;

FIG. 6 is a plan view of a strain sensor according to a first variation in accordance with aspects of the present disclosure;

FIG. 7 is a plan view of a strain sensor according to a second variation in accordance with aspects of the present disclosure;

FIG. 8 is a plan view of a strain sensor according to a third variation in accordance with aspects of the present disclosure;

FIG. 9 is an enlarged plan view of a dense wire part in the strain sensor of FIG. 8 in accordance with aspects of the present disclosure; and

FIG. 10 is a plan view of a strain sensor according to a fourth variation in accordance with aspects of the present disclosure.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

Of a substrate forming a strain sensor, a region located in a sensing part is referred to as a “sensing region”, and regions located around the sensing part are referred to as “peripheral regions”. For example, detection wires are not only disposed in the sensing region of the substrate but may also be laid out to extend to the peripheral regions of the substrate. To further improve the detection accuracy of such a strain sensor, it is desired to configure the strain sensor such that the deformation of the peripheral regions of the substrate can be suppressed without hindering the stretching and contraction of the substrate and the detection wires in a predetermined direction in response to the strain of a target object in a measurement region.

In view of the above, the present disclosure is directed to the deformation of the peripheral regions can be suppressed without hindering the stretching and contraction of the sensing region in the predetermined direction by extending two or more detection wires to the sensing region of the substrate and to two peripheral regions (hereafter referred to as a “first region” and a “second region”) disposed to face each other in the extension direction (hereafter referred to as a “first direction”) of the detection wires across the sensing region of the substrate and by providing a dense wire part of one of the detection wires in each of the first and second regions. Based on these new findings, the present inventors have arrived at the present disclosure.

An aspect of the present disclosure is described below with reference to the drawings. However, the present disclosure is not limited to the aspects described below. Also, the same reference number is assigned to substantially the same components throughout the drawings.

In the descriptions below, for explanatory convenience, terms, such as “upper”, “lower”, “right”, “left”, and “side”, are used to indicate directions based on an assumption that a strain sensor is used in a normal condition. However, these terms do not limit the conditions in which a strain sensor of the present disclosure is used.

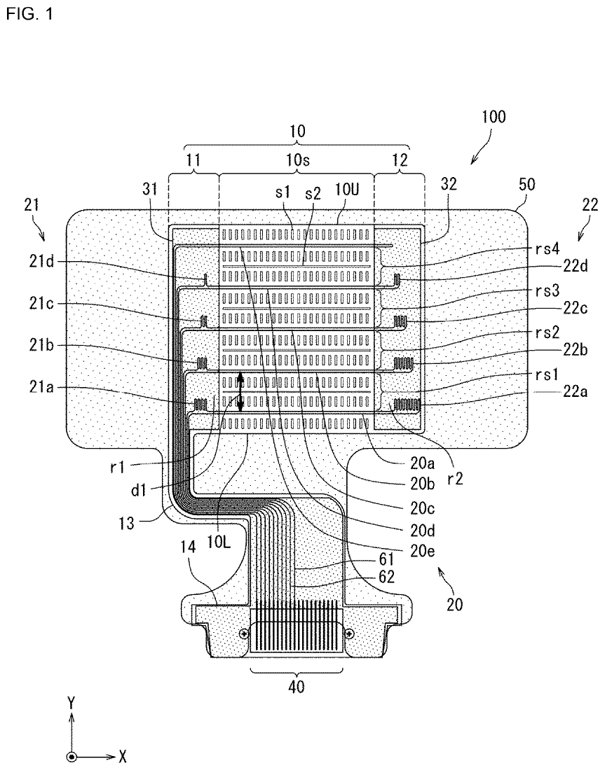

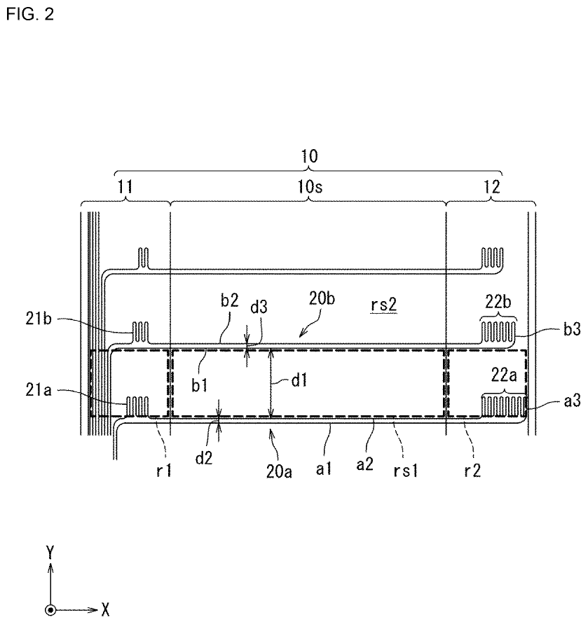

FIG. 1 is a plan view of a strain sensor according to an aspect of the present disclosure. FIG. 2 is an enlarged plan view of a part of the strain sensor of FIG. 1.

As illustrated in FIGS. 1 and 2, a strain sensor 100 according to the present aspect includes a substrate 10 that is stretchable and contractible and multiple wires 20a to 20e (may be collectively referred to as “wires 20”) disposed on or in the major surface of the substrate 10. The strain sensor 100 may further include multiple terminal parts 40 and a fixing part 50 that supports at least a part of the substrate 10. In the present disclosure, in the plan views of FIGS. 1 and 2, the horizontal direction is referred to as an x direction, a direction (vertical direction) perpendicular to the x direction is referred to as a y direction, and the thickness direction of the substrate 10 is referred to as a z direction.

The substrate 10 has a major surface and a back surface facing the major surface. When the strain sensor 100 is used, the back surface of the substrate 10 faces, for example, a target object. In plan view, the substrate 10 includes a sensing region 10s, a first region 11, and a second region 12. The sensing region 10s can stretch and contract in the first direction (in this example, the x direction). The first region 11 and the second region 12 are disposed to face each other in the first direction (the x direction) across the sensing region 10s. For example, the sensing region 10s can stretch and contract in the x direction in response to the deformation of a target object to be measured. Here, “plan view” refers to a view from the normal direction of the major surface of the substrate 10, in other words, a view from above the major surface of the substrate 10 in the thickness direction (the z direction) of the substrate 10.

The sensing region 10s includes a lower-end portion 10L and an upper-end portion 10U that face each other in the y direction, and a right-end portion and a left-end portion that face each other in the x direction. In this example, the left-end portion of the sensing region 10s is in contact with the first region 11, and the right-end portion of the sensing region 10s is in contact with the second region 12. The substrate 10 may be a continuous sheet including the sensing region 10s, the first region 11, and the second region 12.

In plan view, the substrate 10 may further include a connection region 13 and a terminal region 14 in which the terminal parts 40 are disposed. The connection region 13 connects the first region 11 and/or the second region 12 (in this example, the first region 11) to the terminal region 14. In the illustrated example, in plan view, the connection region 13 extends downward Each of the multiple wires 20 is, for example, a detection wire whose resistance value varies when being stretched or contracted. The multiple wires 20 are electrically isolated from each other. Each wire 20 extends over the first region 11, the sensing region 10s, and the second region 12. As described below, each wire 20 may have a folded structure. As illustrated in FIG. 1, each wire 20 may also extend to the connection region 13 and the terminal region 14. Each of the two ends of the wire 20 is electrically connected to the corresponding one of the terminal parts 40. In the present disclosure, a part of the wire 20 located in the sensing region 10s may be referred to as a “detection part”, parts of the wire 20 located in the first region 11 and the second region 12 may be referred to as “leading parts”, and a part of the wire 20 located in the connection region 13 and the terminal region 14 may be referred to as a “connection part”. The detection part of the wire 20 may be shaped like, for example, a straight line extending in the x direction. As long as the detection part extends in the first direction (the x direction), the detection part may include a straight part and/or a curved part, and may also include a bent part (or a curvature part).

In the example illustrated in FIG. 1, five wires 20a to 20e are arranged in this order in the sensing region 10s from the lower-end portion 10L toward the upper-end portion 10U such that the wires 20a to 20e are spaced apart from each other in a second direction (in this example, the y direction) that is orthogonal to the first direction. In the sensing region 10s, the detection parts of the wires 20a to 20e may be arranged in parallel with each other. In the sensing region 10s, regions rs1 to rs4, each of which is located between two wires 20 that are adjacent to each other in the Y direction, are referred to as “inter-wire regions”. Distances (maximum distances) d1 of the inter-wire regions rs1 to rs4 in the y direction may be equal to each other. This configuration enables the displacement of the target object in the y length or width to be more accurately measured.

The wire 20a includes a first dense wire part 21a in the first region 11 and a second dense wire part 22a in the second region 12. In the present disclosure, a “dense wire part” refers to a part of a wire in which the wire is laid out more densely than in the sensing region 10s. The dense wire part may have, for example, a meander shape. Similarly, the wires 20b to 20d, respectively, include first dense wire parts 21b to 21d in the first region 11 and second dense wire parts 22b to 22d in the second region 12. One or more of the wires (in this example, the wire 20e) may include no dense wire part.

The first dense wire parts 21a to 21d (which may be collectively referred to as “first dense wire parts 21”) of the wires 20a to 20d may be arranged at intervals in the y direction in the first region 11. Similarly, the second dense wire parts 22a to 22d (which may be collectively referred to as “second dense wire parts 22”) of the wires 20a to 20d may be arranged at intervals in the y direction in the second region 12.

The number of wires 20 in the strain sensor 100 is not limited to any specific value. The strain sensor 100 may include at least two wires 20 (which may be referred to as a “first wire” and a “second wire”). In the present aspect, at least one of the first wire and the second wire includes the first dense wire part 21 in the first region 11, and at least one of the first wire and the second wire includes the second dense wire part 22 in the second region 12.

Below, a more detailed wire structure is described with reference to FIG. 2 using an example in which the “first wire” is the wire 20a and the “second wire” is the wire 20b. Each of the first wire and the second wire may correspond to any other wire.

The wire 20a and the wire 20b are arranged in the sensing region 10s and spaced apart from each other in the y direction. In plan view, the wire 20b is disposed between the wire 20a and the upper-end portion 10U (i.e., higher than the wire 20a).

In plan view, at least a portion (in this example, the entirety) of the first dense wire part 21a of the wire 20a is disposed in a first adjacent region r1 of the first region 11 that is adjacent to the inter-wire region rs1. At least a part (in this example, the entirety) of the second dense wire part 22a of the wire 20a is disposed in a second adjacent region r2 of the second region 12 that is adjacent to the inter-wire region rs1. In other words, in plan view, the first dense wire part 21a and the second dense wire part 22a are disposed to face each other across the inter-wire region rs1. Similarly, at least a part of the first dense wire part 21b of the wire 20b is disposed in a region of the first region 11 adjacent to the inter-wire region rs2, and at least a part of the second dense wire part 22b of the wire 20b is disposed in a region of the second region 12 adjacent to the inter-wire region rs2.

Also, as illustrated in FIG. 2, in plan view, the wire 20a includes an extending part a1 (also referred to as a “first extending part”), an extending part a2 (also referred to as a “second extending part”), and a folded part a3 (also referred to as a “first folded part”) that connects the end portions (in this example, the right end portions) of the extending parts a1 and a2 to each other. Each of the extending parts a1 and a2 extends over the first region 11, the sensing region 10s, and the second region 12. The folded part a3 is disposed in either the first region 11 or the second region 12 (in this example, the second region 12). In the present application, this wire structure is referred to as a “folded structure”.

The folded part a3 may have any structure that reverses the direction in which the wire 20a extends. The first dense wire part 21 (or the second dense wire part 22) may include a portion that functions as a folded part. As illustrated in FIG. 2, a part of the second dense wire part 22 with a meander shape may function as the folded part a3.

In the sensing region 10s, the extending parts a1 and a2 are disposed apart from each other in the y direction by an interval d2 (“first interval”). In the sensing region 10s, the extending parts a1 and a2 may be parallel to each other. The first interval d2 between the extending parts a1 and a2 is less than the distance d1 (in this example, the length of the inter-wire region rs1 in the y direction) between two wires 20a and 20b that are adjacent to each other in the y direction. The distance d1 is, for example, 5 mm, and the first interval d2 is, for example, 0.5 mm.

In plan view, among the two extending parts a1 and a2 of the wire 20a, the extending part a1 closer to the lower-end portion 10L is referred to as a “lower extending part”, and the extending part a2 closer to the upper-end portion 10U (or closer to the wire 20b) is referred to as an “upper extending part”. In this example, the first dense wire part 21a and the second dense wire part 22a are formed in the upper extending part a2 of the wire 20a. This configuration enables the first dense wire part 21a and the second dense wire part 22a to be placed in the regions r1 and r2 adjacent to the first inter-wire region rs1. The lower extending part a1 of the wire 20a does not necessarily include a dense wire part.

Similarly to the wire 20a, the wire 20b includes a lower extending part b1 (also referred to as a “third extending part”), an upper extending part b2 (also referred to as a “fourth extending part”), and a folded part b3 (also referred to as a “second folded part”) (folded structure). Each of the extending parts b1 and b2 extends over the first region 11, the sensing region 10s, and the second region 12. The folded part b3 is disposed in either the first region 11 or the second region 12 (in this example, the second region 12). In the sensing region 10s, the extending parts b1 and b2 are arranged in the y direction at an interval d3 (“second interval”). The second interval d3 is less than the distance d1 in the Y direction between the wires 20a and 20b. The second interval d3 may be the same as the first interval d2. The first dense wire part 21b and the second dense wire part 22b of the wire 20b may be formed in the upper extending part b2. This configuration facilitates the first dense wire part 21b and the second dense wire part 22b to be placed in the regions adjacent to the inter-wire region rs2.

Although the wires 20a and 20b are used in the example described above, other wires 20c to 20e may also have a folded structure as illustrated in FIG. 1. Also, the first dense wire part 21c and the second dense wire part 22c of the wire 20c (which may also be referred to as a “third wire”) may be disposed in regions adjacent to the inter-wire region rs3. Similarly, the first dense wire part 21d and the second dense wire part 22d of the wire 20d (which may also be referred to as a “fourth wire”) may be disposed in regions adjacent to the inter-wire region rs4. The dense wire parts of the wires 20c and 20d may be formed in the upper extending parts of the wires 20c and 20d.

Although dense wire parts are formed in the upper extending parts of the wires 20 in FIG. 1, dense wire parts may be formed in the lower extending parts of the wires 20. In this case, the first dense wire part and the second dense wire part of the wire 20b may be disposed in the first adjacent region r1 and the second adjacent region r2 that are adjacent to the inter-wire region rs1. Also, the first dense wire part and the second dense wire part of the wire 20c may be disposed in the regions adjacent to the inter-wire region rs2.

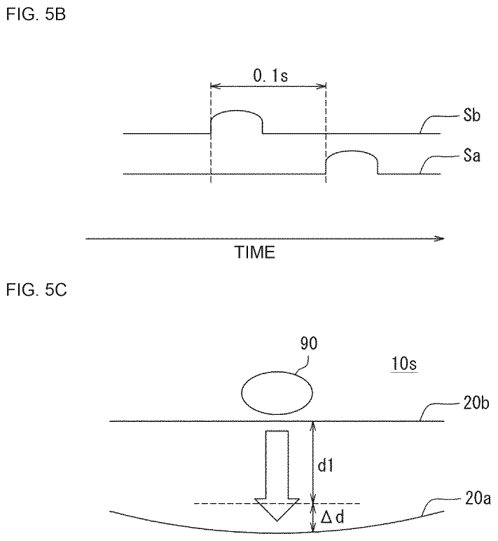

According to the present aspect, at least one dense wire part 21 and at least one dense wire part 22 are formed, respectively, in the first region 11 and the second region 12 that are disposed on the sides of the sensing region 10s of the substrate 10. This configuration suppresses the deformation (stretching and contraction) of the first region 11 and the second region 12 and thereby reduces the influence of the deformation of the first region 11 and the second region 12 on the detection results of strain in the sensing region 10s. Accordingly, strain generated in a measurement region can be more accurately detected by attaching the strain sensor 100 such that the measurement region and the sensing region 10s face each other. For example, it is possible to reduce measurement errors caused by the stretching and contraction of the wires 20 (e.g., leading parts of the wires 20) resulting from the deformation of the first region 11 and the second region 12. Also, the above configuration suppresses the deformation (stretching and contraction) of the sensing region 10s in the y direction due to the deformation of the first region 11 and the second region 12 and thereby reduces, for example, the distortion of the wires 20 in the sensing region 10s and the variation in the distance d1 between the wires 20. This configuration in turn reduces measurement errors (such as a measurement error in the amount of displacement of a target object) resulting from, for example, the distortion of the wires 20 and the variation in the distance d1 and thereby improves the detection accuracy. The influence of the variation in the distance d1 on detection results is described below with reference to FIG. 5C.

Here, in the strain sensor disclosed in Patent Document 1, the wires are folded near the center of the sensing region and do not extend to the sides of the sensing region. In contrast, in the present aspect, the wires 20 are intentionally extended to the sides of the sensing region 10s to suppress the deformation of the first region 11 and the second region 12. Also, forming dense wire parts in both of the first region 11 and the second region 12 suppresses the deformation of the first region 11 and the second region 12 in a balanced manner and thereby further reduces its influence on detection accuracy. Furthermore, compared with a case in which the wires 20 extend only to one side of the sensing region 10s, the above configuration more effectively suppresses the deformation of the sensing region 10s in the y direction and reduces the variation in the distance d1 between the wires 20a and 20b.

Also, according to the present aspect, at least one wire (in this example, the wires 20a to 20d) includes both of the first dense wire part 21 and the second dense wire part 22. This configuration more efficiently suppresses the deformation of the substrate 10 on both sides of portions (detection parts) of the wires located in the sensing region 10s. This configuration in turn further improves the accuracy of detection using the wires.

Also, in the present aspect, the first dense wire part 21a and the second dense wire part 22a of one of the wires (in this example, the wire 20a) are disposed, respectively, in the first adjacent region r1 and the second adjacent region r2 that are adjacent to the inter-wire region rs1. This configuration more effectively suppresses the variation in the distance d1 of the inter-wire region rs1 in the y direction even when the strain sensor 100 is attached to a measurement region and tension is applied to the first region 11 and the second region 12 of the substrate 10. In plan view, dense wire parts of the corresponding one of the wires 20 may be disposed on the sides of each of the inter-wire regions rs1 to rs4 in the sensing region 10s. This configuration suppresses the variation in the distance d1 between two adjacent wires 20 throughout the entire sensing region 10s.

Also, according to the present aspect, each wire 20 has a folded structure. This configuration enables the strain of a target object located in a position corresponding to the wire 20 to be measured by using two extending parts that are electrically connected to each other. This in turn improves measurement accuracy. Furthermore, by forming a dense wire part in either the upper extending part or the lower extending part of each wire 20, it is possible to position the dense wire part adjacent to a desired inter-wire region.

Each component of the strain sensor 100 is described in more detail below.

The substrate 10 is preferably formed of a stretchable material with a small elastic modulus and preferably includes a stretchable material with a small elastic modulus, such as polyurethane, acrylic, styrene, or silicone resin. As a non-limiting example, the thickness of the substrate 10 is preferably greater than or equal to 10 μm and less than or equal to 200 μm, more preferably greater than or equal to 20 μm and less than or equal to 100 μm, and even more preferably greater than or equal to 30 μm and less than or equal to 50 μm.

The size of the sensing region 10s in plan view may be set taking into account the size of a measurement region of a target object to be measured. In this example, the outer edge of the sensing region 10s has a rectangular shape with sides extending in the x and y directions. Each of the first region 11 and the second region 12 may have any size in plan view as long as multiple wires 20 including dense wire parts can be placed therein. The width in the x direction of each of the first region 11 and the second region 12 may be less than the width of the sensing region 10s. The width in the y direction of each of the first region 11 and the second region 12 may be the same as the width of the sensing region 10s.

Preferably, the sensing region 10s is more likely to be deformed in the first direction (the x direction) than the first region 11 and the second region 12. In other words, the sensing region 10s is preferably configured to have higher responsiveness to the strain of a target object compared with the first region 11 and the second region 12. The responsiveness of the sensing region 10s can be set taking into account the flexibility of the target object. In this example, the sensing region 10s has multiple slits s1 extending in a direction (for example, the y direction) that intersects the x direction in which the wires 20 stretch and contract. The slits s1 may be arranged at intervals in the x direction in each of the inter-wire regions rs1 to rs4. The slits s1 may also be formed in a region between the wire 20a and the lower-end portion 10L and a region between the wire 20e and the upper-end portion 10U. The sensing region 10s may also have multiple slits s2 that extend in the x direction. Each of the slits s2 may be positioned between two adjacent wires 20. On the other hand, it is preferable that no slit is formed in the first region 11 and the second region 12. This configuration makes the sensing region 10s more easily deformable in the x direction compared with the first region 11 and the second region 12.

The size, number, and arrangement of the slits formed in the substrate 10 are not limited to the examples illustrated in FIG. 1 and may be appropriately set to achieve desired responsiveness. Also, the positions and shapes of regions (the sensing region 10s, the first region 11, the second region 12, the connection region 13, and the terminal region 14) of the substrate 10 are not limited to the examples illustrated in FIG. 1.

Each wire 20 includes a detection part disposed in the sensing region 10s and leading parts disposed in the first region 11 and the second region 12. The wire 20 may further include connection parts 61 and 62 that are disposed in the connection region 13 and the terminal region 14 and connect the wire 20 to the terminal parts 40.

At least the detection part of the wire 20 is preferably formed of a material whose resistance value greatly varies in response to stretching and contraction. The material of the detection part of the wire 20 may be comprised of a mixture including metal powder of, for example, silver (Ag) or copper (Cu) and an elastomer resin, such as silicone. When the wire 20 (or at least the detection part of the wire 20) is formed of a mixture of metal powder and resin, the contact points between particles of the metal powder increase and decrease and the distance between particles of the metal powder increases in response to the stretching and contraction of the sensing region 10s, and the increase rate or the decrease rate of the resistance value in response to displacement can be increased. Also, the elasticity of the resin prevents the breaking of the wire 20 due to deformation.

The materials of the detection part and the leading parts of the wire 20 may be the same. In the present aspect, the dense wire parts 21 and 22 suppress the stretching and contraction of the leading parts of the wire 20. Therefore, even when the materials of the leading parts and the detection part are the same, the influence of the stretching and contraction of the leading parts on the detection result (the variation in the resistance value of the wire 20) can be reduced. The material of the connection parts 61 and 62 may also be the same as the material of the detection part. Using the same material for the entire wire 20 makes it possible to form the wire 20 in a single process (by, for example, a printing method) and thereby form the wire 20 at low cost.

Alternatively, parts (e.g., the leading parts and the connection parts 61 and 62) other than the detection part of the wire 20 may be formed of a material different from the material of the detection part. In this case, a material with a lower resistance value than the material of the detection part may be selected for the parts other than the detection part to enable detection of strain with higher accuracy.

The width (line width) of the detection part of the wire 20 may be, for example, but not limited to, 0.3 mm. The width and film thickness of the leading parts may be the same as the width and film thickness of the detection part. The overall lengths (wire lengths) of the wires 20 are preferably the same. In the present aspect, the wire lengths of the multiple wires 20 can be made equal by adjusting the lengths of the portions of the wires 20 forming the dense wire parts.

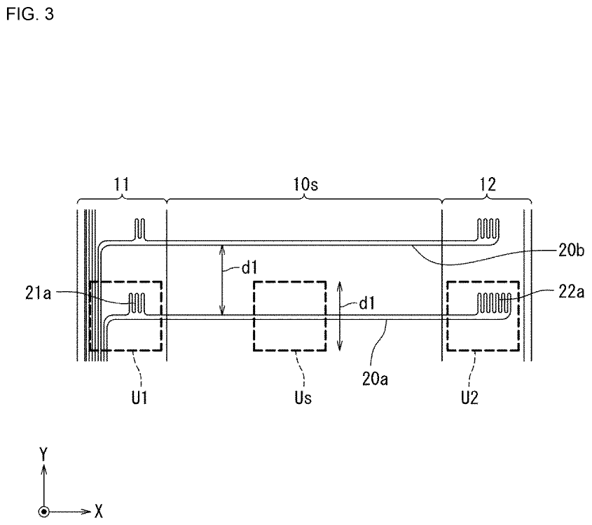

In the present aspect, as in the plan view of FIG. 3, the first dense wire part 21a of the wire 20a is preferably formed such that the wire density in a unit region U1 of the first region 11 including the first dense wire part 21a is higher than the wire density in a unit region Us of the sensing region 10s including the wire 20a. Similarly, the second dense wire part 22a of the wire 20a is preferably formed such that the wire density in a unit region U2 of the second region 12 including the second dense wire part 22a is higher than the wire density in the unit region Us of the sensing region 10s. Here, in plan view, “unit region” is a square region each side of which has a length corresponding to the distance d1 in the y direction between two adjacent wires 20a and 20b. Also, “wire density” indicates the proportion of the area occupied by a wire (in this example, the wire 20a) in the unit region.

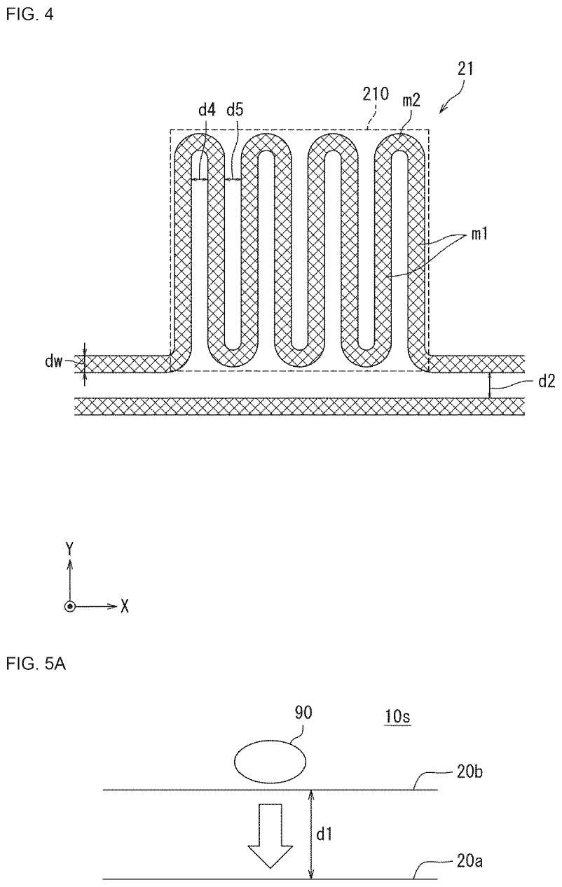

FIG. 4 is an enlarged plan view illustrating an example of the first dense wire part 21 in the strain sensor 100. In this example, the first dense wire part 21 is described. However, the second dense wire part 22 may also have a similar shape.

The first dense wire part 21 illustrated in FIG. 4 has a meander shape. In plan view, the meander shape may include two or more (preferably, four or more) straight parts m1 extending in a direction (preferably, the y direction) intersecting the x direction and at least one (preferably, multiple) bent part m2 that is bent to form a protrusion protruding in the y direction.

Each of wire intervals d4 and d5 (in this example, the distance between two adjacent straight parts m1) in the first dense wire part 21 may be less than, for example, the interval (in this example, the first interval d2) between the extending parts of the wire 20. The minimum value of each of the intervals d4 and d5 may be less than or equal to a wire width dw or a value obtained by adding a length tolerance to the wire width dw. The wire width dw is, for example, 0.3 mm±0.1 mm (0.1 mm is a tolerance), and the minimum value of each of the intervals d4 and d5 may be, for example, 0.2 mm.

According to the present aspect, each of the first dense wire part 21 and the second dense wire part 22 has a meander shape including the straight parts m1 described above. This configuration more effectively suppresses the deformation of the first region 11 and the second region 12 in the y direction without hindering the sensing region 10s and the detection part of the wire 20 from stretching and contracting in the x direction in response to the strain of a target object.

The configuration of the dense wire part is not limited to the example illustrated in FIG. 4. The size (area) of the dense wire part, the extension direction of the straight parts m1 in the dense wire part, the number of the straight parts m1, the wire intervals d4 and d5, and the area ratio between a region occupied by the wire and a region not occupied by the wire in the dense wire part may be set appropriately. Also, the meander shape of the dense wire part does not necessarily include the straight parts m1, and the dense wire part may have a winding shape comprised of curved lines. As described below, the dense wire part may have any other planar shape, such as a double winding shape.

The area of a dense wire part may be appropriately set depending on, for example, its position in the y direction. “Area of dense wire part” indicates, in plan view, the area of a region including a wire portion in which a wire is densely laid out and a non-wire portion that is enclosed or defined by the wire portion. In the example illustrated in FIG. 4, the area of the first dense wire part 21 indicates the area of a virtual rectangle 210 that contacts the outermost edge of the meander shape of the wire 20.

The multiple first dense wire parts 21 disposed in the first region 11 illustrated in FIG. 1 may include at least two first dense wire parts with different areas. Similarly, the multiple second dense wire parts 22 disposed in the second region 12 may include at least two second dense wire parts with different areas.

In the present aspect, in plan view, the multiple first dense wire parts 21 and/or the multiple second dense wire parts 22 may have different areas depending on their positions in the y direction. With this configuration, it is possible to make the area of a dense wire part provided in a particularly deformable position in the first region 11 and the second region 12 greater than the areas of dense wire parts in other positions taking into account the application of the strain sensor and the structures of components of the strain sensor other than the wires. This configuration in turn more efficiently suppresses the deformation of the first region 11 and the second region 12.

For example, when the strain sensor 100 is used to detect the movement of the throat caused by swallowing, because the amount of movement of the shoulder is greater than the amount of movement of the neck, the multiple wires 20 may be configured such that the area of the lowest dense wire part closest to the shoulder is largest, and the areas of dense wire parts decrease as the distance from the shoulder increases (as the distance from the lowest part may increase in the y direction). Specifically, as illustrated in FIG. 1, the wires 20a to 20e may be configured such that the areas of the first dense wire parts 21a to 21d decrease in this order and the areas of the second dense wire parts 22a to 22d decrease in this order.

The relationship among the areas of the dense wire parts is not limited to the above example. For example, when the central portions in the y direction of the first region 11 and the second region 12 are particularly deformable due to the application of the strain sensor 100, the dense wire parts in the central portions may have the largest area.

Also, in plan view, the areas of the first dense wire part 21a and the second dense wire part 22a, which are disposed on the corresponding sides of the inter-wire region rs1, may be different from each other. Similarly, the areas of the first dense wire part 21 and the second dense wire part 22, which are disposed on the corresponding sides of each of the inter-wire regions rs2 to rs4, may be different from each other. This configuration controls the ease of deformation of the first region 11 and the second region 12 by adjusting the areas of dense wire parts.

In the strain sensor 100 illustrated in FIG. 1, the connection parts 61 and 62 of each wire 20 extend in the y direction in the first region 11, but not in the second region 12. Therefore, when the first dense wire part 21 and the second dense wire part 22 have the same area, the first region 11 may become less likely to deform in the y direction compared with the second region 12. The difference in hardness (resistance to deformation) between the first region 11 and the second region 12 can be reduced by making the area of the second dense wire part 22 in the second region 12 greater than the area of the first dense wire part 21.

The areas of the dense wire parts are not limited to the examples described above. The areas of all first dense wire parts 21 may be the same. Similarly, the areas of all second dense wire parts 22 may be the same. Furthermore, the areas of two dense wire parts 21 and 22 disposed on the sides of each of the inter-wire regions rs1 to rs4 may be the same.

For example, the strain sensor 100 is attached to a target object (such as a human body) such that the sensing region 10s faces a measurement region of the target object. In the example described below, the movement of the throat caused by swallowing is detected using the strain sensor 100.

The strain sensor 100 is attached to the skin of the anterior neck of a subject to cover the range (measurement region) in which the thyroid cartilage moves. For example, the strain sensor 100 is placed such that the lower-end portion 10L of the sensing region 10s is located on the lower side (shoulder side) of the measurement region and the upper-end portion 10U is located on the neck side of the measurement region. The strain sensor 100 is preferably attached such that the vertical movement direction of the thyroid cartilage intersects (preferably, at a right angle) the x direction in which the multiple wires 20 stretch and contract. The sensing region 10s of the substrate 10 deforms due to the displacement of the thyroid cartilage caused by swallowing performed by the subject, and as a result, some of the wires 20 stretch and contract. When the thyroid cartilage is located below a certain wire 20, the wire 20 stretches due to a swell resulting from the thyroid cartilage, and the resistance value of the wire 20 increases. For example, the strain sensor 100 generates an output signal based on a change in the resistance value resulting from the stretching or contraction of each wire 20.

As illustrated in FIG. 5A, when the wires 20a and 20b are arranged parallel to each other at the predetermined distance d1 (e.g., 5 mm) in the sensing region 10s and a thyroid cartilage 90 moves up and down to cross two or more wires 20, the direction and speed of movement of the thyroid cartilage 90 can be estimated based on the temporal variations of the resistance values of the wires 20a and 20b. FIG. 5B shows examples of output signals Sa and Sb of the wires 20a and 20b observed when the thyroid cartilage 90 moves downward to cross the wires 20a and 20b. Based on the results shown in FIG. 5B, it can be estimated that the thyroid cartilage 90 has moved downward by 0.5 mm in 0.1 seconds.

Even when the thyroid cartilage moves forward or backward (deformed in the z direction), the wirings 20a and 20b expand and contract according to the position and the amount of movement of the forward or backward movement, and the resistance value changes and increases. Specifically, when the wirings 20a and 20b are extended, the resistance increases, and when the wirings are contracted, the resistance decreases. In other words, when the thyroid cartilage moves forward, the resistance increases because the wires 20a and 20b act in the direction of extension. When the wirings 20a and 20b move backward and return to the I added the details, so please check if there are any problems with the translation. original position, the resistance decreases because the wirings a and b act in the direction of contraction.

Therefore, it is possible to estimate the amounts of forward and backward movements of the thyroid cartilage. According to the present aspect, because each wire 20 is fixed by the dense wire parts on both sides of the sensing region 10s, not only the upward and downward movements of the thyroid cartilage but also the forward and backward movements of the thyroid cartilage can be more accurately detected.

As described above, if the sensing region of the substrate 10 stretches or contracts in the y direction when, for example, the strain sensor 100 is attached and the distance d1 between the wires 20a and 20b changes, a measurement error may occur. FIG. 5C is a comparative example showing a state in which the distance d1 (for example, 5 mm) between the wires 20a and 20b has increased by Δd (for example, 2 mm). When, for example, the downward movement of the thyroid cartilage 90 is detected in this state and output signals Sa and Sb similar to those in FIG. 5B are obtained, it is mistakenly detected that the thyroid cartilage 90 has only moved 5 mm (=d1) downward in 0.1 seconds even though the thyroid cartilage 90 has actually moved 7 mm (=d1+Δd) downward. In contrast, with the strain sensor 100 of the present aspect, because the variation in the distance d1 between wires is suppressed by the dense wire parts, the displacement of a target object can be more accurately measured.

The strain sensor 100 may further include a first upper layer 31 provided on at least a part of the first region 11 of the substrate 10. Furthermore, the strain sensor 100 may include a second upper layer 32 provided on at least a part of the second region 12 of the substrate 10. In the example illustrated in FIG. 1, the first upper layer 31 is disposed to cover the multiple wires 20, and the second upper layer 32 is disposed to cover the multiple wires 20.

Each of the first upper layer 31 and the second upper layer 32 is, for example, a resin layer formed of a UV-curable urethane-modified acrylic resin. The first upper layer 31 may extend to the connection region 13 and the terminal region 14 to cover the connection parts 61 and 62 of the wires 20. As illustrated in FIG. 1, the first upper layer 31 and the second upper layer 32 preferably do not extend to the sensing region 10s and do not cover the detection parts of the wires 20.

With the first upper layer 31 provided, the thickness of a portion (hereafter referred to as a “first peripheral part”) of the strain sensor 100 where the first region 11 is located can be made greater than the thickness of a portion (hereafter referred to as a “sensing part”) of the strain sensor 100 where the sensing region 10s is located. Similarly, with the second upper layer 32 provided, the thickness of a portion (hereafter referred to as a “second peripheral part”) of the strain sensor 100 where the second region 12 is located can be made greater than the thickness of the sensing part. Here, the “thickness of the first peripheral part” is the thickness of the strain sensor 100 through the first region 11 in the z direction, and the “thickness of the second peripheral part” is the thickness of the strain sensor 100 through the second region 12 in the z direction. The “thickness of the sensing part” is the thickness of the strain sensor 100 through the sensing region 10s in the z direction.

The strain sensor 100 may further include a protective layer (may also be referred to as a “third upper layer”) that is disposed on the sensing region 10s of the substrate 10 to cover the multiple wires 20. The material of the protective layer may be either the same as or different from the material of the first upper layer 31 and the second upper layer 32. The protective layer may be provided only on the sensing region 10s or may extend across the entire substrate 10. For example, the protective layer may cover the first upper layer 31, the second upper layer 32, and the sensing region 10s.

When the protective layer, the first upper layer 31, and the second upper layer 32 are formed of the same material, the thickness of the protective layer is preferably less than the thicknesses of the first upper layer 31 and the second upper layer 32.

When the protective layer and the first and second upper layers 31 and 32 are formed of different materials, the material of the first upper layer 31 and the second upper layer 32 is preferably harder (i.e., has a higher Young's modulus) than the material of the protective layer. In exemplary aspects, any known resin material can be used for the protective layer. This configuration enables the first peripheral part and the second peripheral part to be harder, i.e., less deformable, than the sensing part.

Making the first peripheral part and the second peripheral part thicker or harder than the sensing part makes it possible to make the first region 11 and the second region 12 even less deformable than the sensing region 10s. This configuration in turn further reduces the influence of the deformation of the first region 11 and the second region 12 on strain measurement in the sensing region 10s.

The strain sensor 100 may further include a fixing part 50 that supports at least a part of the substrate 10. The fixing part 50 is disposed on, for example, the back side of the substrate 10. In plan view, the fixing part 50 may be disposed such that the entire substrate 10 overlaps the major surface of the fixing part 50. Alternatively, the fixing part 50 may have an opening or a cutout at a position corresponding to the sensing region 10s. In this case, in plan view, at least a part of the sensing region 10s may overlap the opening or cutout in the fixing part 50. Examples of materials for the fixing part 50 include rubber, such as urethane rubber and silicon rubber, and a sponge, such as a chloroprene rubber sponge.

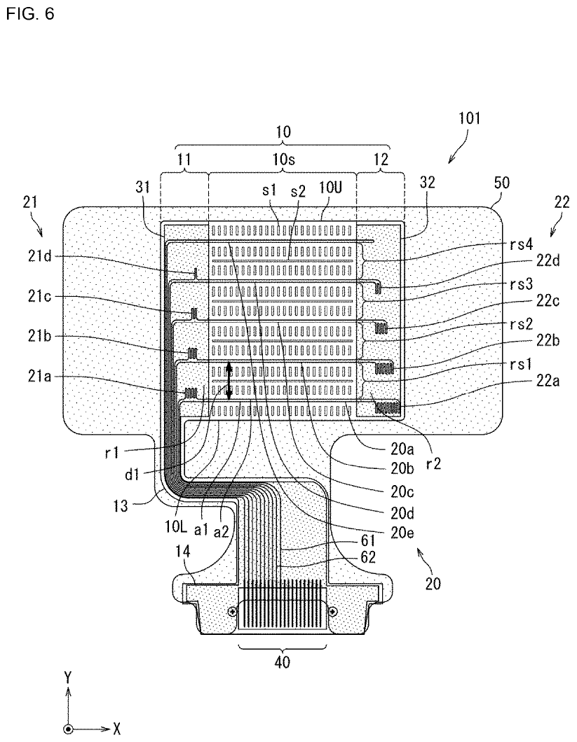

FIG. 6 is a plan view of a strain sensor 101 according to a first variation. In plan view, the strain sensor 101 is different from the strain sensor 100 illustrated in FIG. 1 in that the first dense wire parts 21a to 21d of the wires 20a to 20d are formed at positions higher than the detection parts of the corresponding wires, and the second dense wire parts 22a to 22d are formed at positions lower than the detection parts of the corresponding wires.

In this variation, dense wire parts of different wires (two wires 20a and 20b defining the inter-wire region rs1) are disposed on the corresponding sides of the inter-wire region rs1. Specifically, the first dense wire part 21a of the wire 20a is disposed in the first adjacent region r1 adjacent to the inter-wire region rs1, and the second dense wire part 22b of the wire 20b is disposed in the second adjacent region r2 adjacent to the inter-wire region rs1. This configuration shifts the first dense wire part 21a on the left side of the inter-wire region rs1 from the second dense wire part 22b on the right side of the inter-wire region rs1 in the y direction. This configuration in turn more efficiently suppresses deformation of the inter-wire region rs1. Similarly, dense wire parts of different wires may be disposed on the corresponding sides of each of the inter-wire regions rs2 and rs3.

In the example illustrated in FIG. 6, the first dense wire part 21a is formed in the upper extending part a2 of the wire 20a, and the second dense wire part 22a is formed in the lower extending part a1 of the wire 20a. Thus, when the wire 20 has a folded structure, one of the first dense wire part 21 and the second dense wire part 22 may be formed in the upper extending part of the wire 20, and the other one of the first dense wire part 21 and the second dense wire part 22 may be formed in the lower extending part.

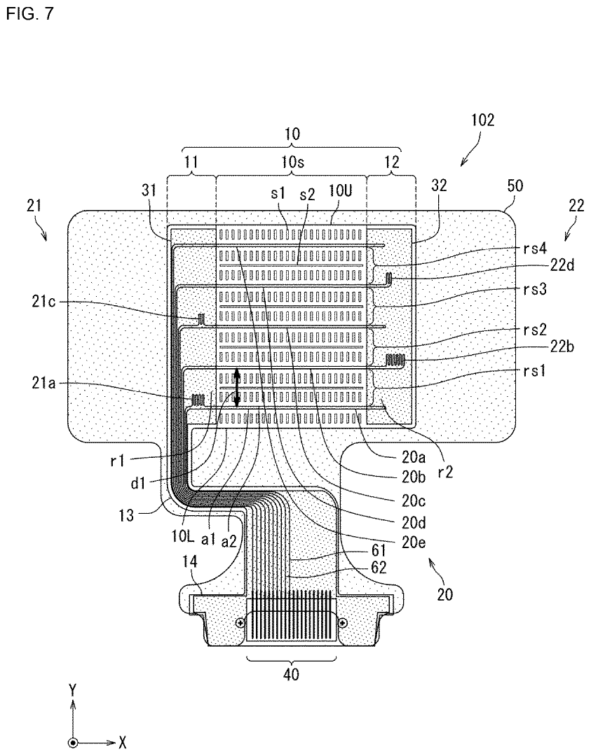

FIG. 7 is a plan view of a strain sensor 102 according to a second variation. In the strain sensor 102, each of the wires 20a to 20d may include a dense wire part only in one of the first region 11 and the second region 12.

In this variation, at least one of the wires 20 (in this example, the wires 20a and 20c) includes the first dense wire part 21, and at least one of the wires 20 (in this example, the wires 20b and 20d) includes the second dense wire part 22. This configuration suppresses deformation of the first region 11 and the second region 12. This configuration also reduces the number of dense wire parts and thereby suppress the increase in wire lengths.

In the example illustrated in FIG. 7, the first dense wire part 21 or the second dense wire part 22 is provided in one of the regions adjacent to each of the inter-wire regions rs1 to rs4. This configuration suppresses the variation in the distance d1 of the inter-wire region rs1 in the y direction.

Also, in the sensing region 10s, the wires 20a and 20c each including the first dense wire part 21 and the wires 20b and 20d each including the second dense wire part 22 may be arranged alternately in the y direction. This configuration suppresses the deformation of the first region 11 and the second region 12 in a balanced manner.

In this variation, in the first region 11, the first dense wire part 21a (which may also be referred to as a “first lower dense wire part”) is provided in at least one of the wires 20a and 20b, and the first dense wire part 21c (which may also be referred to as a “first upper dense wire part” or a “third dense wire part”) is provided in at least one of the wires 20c and 20d. The first upper dense wire part 21c is disposed higher (closer to the upper-end portion 10U) than the first lower dense wire part 21a. Similarly, in the second region 12, the second dense wire part 22b (which may also be referred to as a “second lower dense wire part”) is provided in at least one of the wires 20a and 20b, and the second dense wire part 22d (which may also be referred to as a “second upper dense wire part” or a “fourth dense wire part”) is provided in at least one of the wires 20c and 20d. The second upper dense wire part 22d is disposed higher (closer to the upper-end portion 10U) than the second lower dense wire part 22b.

The areas of the first upper dense wire part 21c and the first lower dense wire part 21a may be different from each other. Also, the areas of the second upper dense wire part 22d and the second lower dense wire part 22b may be different from each other. As an example, as illustrated in FIG. 7, the area of the first dense wire part 21c may be less than the area of the first dense wire part 21a, and the area of the second dense wire part 22d may be less than the area of the second dense wire part 22b. Varying the areas of the first dense wire parts 21 and the second dense wire parts 22 according to their positions in the y direction makes it possible to more efficiently suppress deformation of the first region 11 and the second region 12.

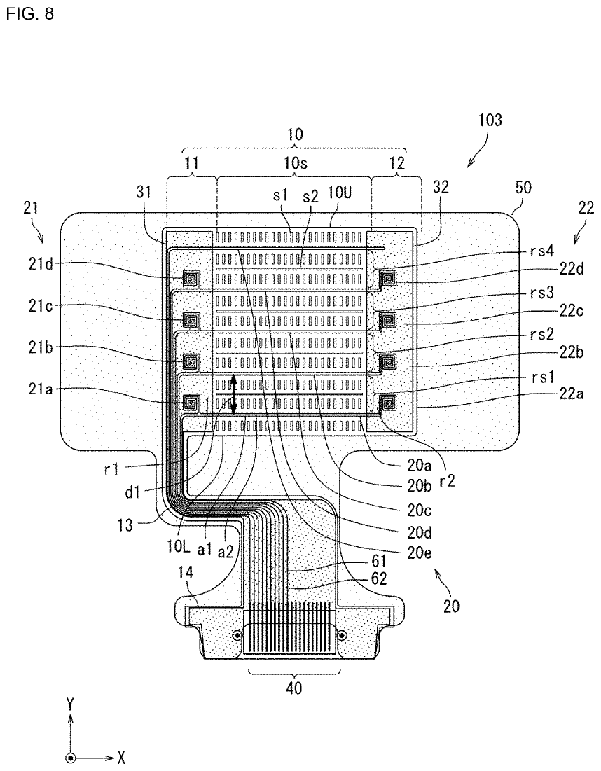

FIG. 8 is a plan view of a strain sensor 103 according to a third variation. In the plan view of the strain sensor 103, each of the first dense wire parts 21 and the second dense wire parts 22 has a double winding shape.

In the example illustrated in FIG. 8, the first dense wire parts 21a to 21d are formed in the upper extending parts of the corresponding wires 20a to 20d. On the other hand, each of the second dense wire parts 22a to 22d is formed of two extending parts of the corresponding one of the wires 20a to 20d. Alternatively, the first dense wire parts 21a to 21d may be formed in the lower extending parts of the corresponding wires 20a to 20d. Also, each of the second dense wire parts 22a to 22d may be formed only in the upper extending part or the lower extending part of the corresponding one of the wires 20a to 20d. In this example, the areas of all dense wire parts are the same. However, the areas of the dense wire parts may be different from each other.

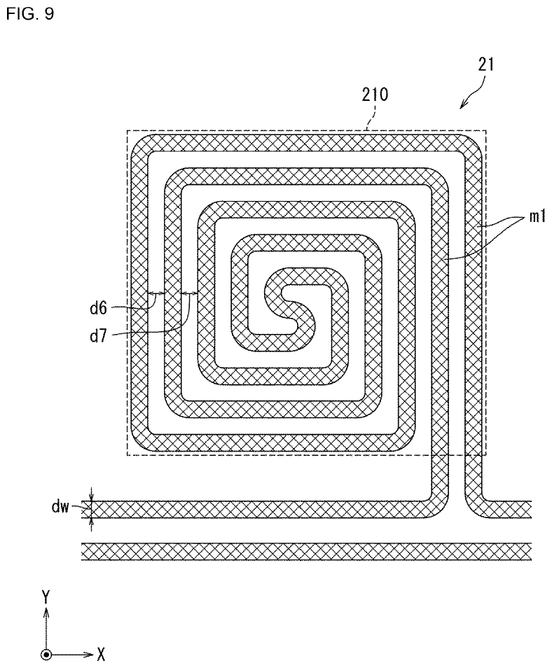

FIG. 9 is an enlarged plan view of an example of a first dense wire part 21 with a double winding shape. In the descriptions below, the first dense wire part 21 is used as an example. However, the second dense wire part 22 may also have a similar shape.

In plan view, the double winding shape may include multiple straight parts m1 that extend in a direction (preferably, the y direction) intersecting the x direction. This configuration more effectively suppresses deformation of the first region 11 in the y direction without hindering the sensing region 10s and the detection part of the wire 20 from stretching and contracting in the x direction in response to the strain of a target object. Intervals d6 and d7 between wire parts forming the double winding shape may be, for example, less than the interval between the two extending parts of the wire 20. The minimum value of the intervals d6 and d7 may be less than or equal to the wire width dw or a value obtained by adding a length tolerance to the wire width dw. The area of the first dense wire part 21 corresponds to the area of a rectangle 210 that contacts the outermost edge of wire parts forming the double winding shape. The area, the number of windings, and the number of straight parts m1 of the dense wire part with the double winding shape are not limited to any particular values. Also, the double winding shape may include no straight part m1 and may be comprised of curved lines.

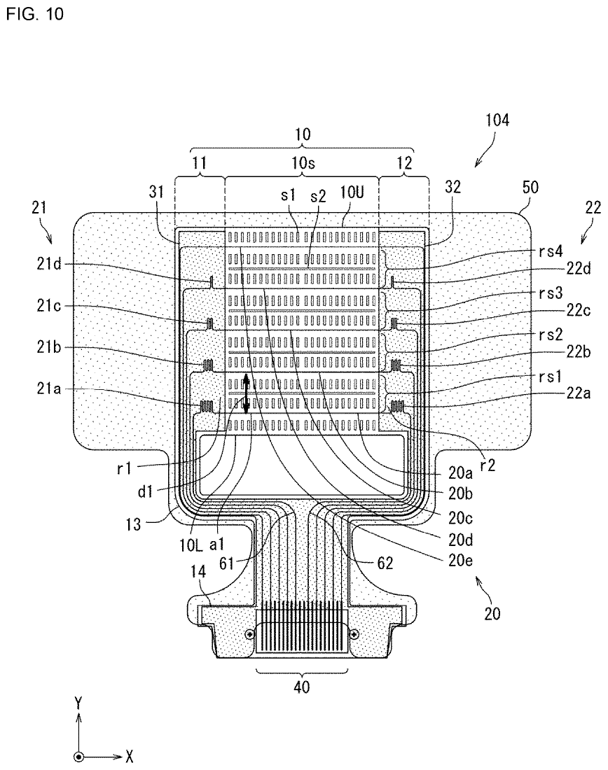

FIG. 10 is a plan view of a strain sensor 104 according to a fourth variation. In the strain sensor 104, each wire 20 does not have the folded structure.

The wire 20a includes one extending part a1 that extends from the first region 11 via the sensing region 10s to the second region 12 and connection parts 61 and 62. The left-end portion of the extending part a1 is electrically connected to the corresponding one of the terminal parts 40 via the connection part 61, and the right-end portion of the extending part a1 is electrically connected to the corresponding one of the terminal parts 40 via the connection part 62. This wire structure is referred to as a “single wire structure”.

The wire 20a includes a first dense wire part 21a in the first adjacent region r1 and a second dense wire part 22a in the second adjacent region r2. In this example, the area of the first dense wire part 21a is the same as the area of the second dense wire part 22a. Other wires 20b to 20e may also have the same single wire structure as the wire 20a.

This variation enables the connection parts 61 and 62 of each wire 20 to be placed separately in the first region 11 and the second region 12 and thereby reduces the difference in the ease of deformation between the first and second regions 11 and 12. Therefore, even when the areas of the first dense wire part 21 and the second dense wire part 22 formed on the sides of each of the inter-wire regions rs1 to rs4 are the same, it is possible to suppress the deformation of the first region 11 and the second region 12 in a balanced manner.

The present disclosure is not limited to the aspect and variations described above and may also be implemented in various other manners. For example, the lengths of the inter-wire regions rs1 to rs4 in the y direction may be set to any appropriate values depending on the purpose and may be different from each other. Also, although each strain sensor in the above examples includes five wires 20a through 20e, a strain sensor may include any number of wires greater than or equal to two.

It is possible to appropriately combine any of the above-described aspects and any of the above-described variations to achieve the corresponding effects.

Although the preferred aspect of the present disclosure is sufficiently described with reference to the accompanying drawings, various modifications and alterations are obvious to those skilled in the art. Such modifications and alterations should be considered to be included in the appended claims as long as they do not depart from the scope of the present disclosure defined by the claims.

In general, the description of the aspects disclosed should be considered as being illustrative in all respects and not being restrictive. The scope of the present disclosure is shown by the claims rather than by the above description and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

10 substrate
10s sensing region
10L lower-end portion
10U upper-end portion
11 first region
12 second region
13 connection region
14 terminal region
20, 20a-20e wire
21, 21a-21d first dense wire part
22, 22a-22d second dense wire part
31 first upper layer
32 second upper layer
40 terminal part
50 fixing part
100-104 sensor
a1 (lower) extending part
a2 (upper) extending part
d1 distance of inter-wire region in second direction
d2 first interval
d3 second interval
r1 first adjacent region
r2 second adjacent region
rs1-rs4 inter-wire region

What is claimed:

1. A strain sensor comprising:
a substrate configured to be stretchable and contractible and that includes a major surface; and
a first wire and a second wire disposed on or in the major surface,
wherein, in a plan view from a normal direction of the major surface, the substrate includes a sensing region configured to be stretchable and contractible in a first direction, and a first region and a second region that face each other in the first direction across the sensing region;
wherein the first wire and the second wire extend over the first region, the sensing region, and the second region; and
wherein the first wire and the second wire are electrically isolated from each other and are arranged in the sensing region at a distance from each other in a second direction that is orthogonal to the first direction.

2. The strain sensor according to claim 1, wherein at least one of the first wire and the second wire includes a first dense wire part that is disposed in the first region and in which a corresponding one of the first wire and the second wire is laid out more densely than in the sensing region.

3. The strain sensor according to claim 2, wherein at least one of the first wire and the second wire includes a second dense wire part that is disposed in the second region and in which a corresponding one of the first wire and the second wire is laid out more densely than in the sensing region.

4. The strain sensor according to claim 3, wherein:
a portion of the first dense wire part is disposed in a region of the first region that is adjacent to an inter-wire region of the sensing region between the first wire and the second wire; and
a part of the second dense wire part is disposed in a region of the second region that is adjacent to the inter-wire region.

5. The strain sensor according to claim 4, wherein the first wire includes the first dense wire part and the second dense wire part.

6. The strain sensor according to claim 4, wherein the first wire includes the first dense wire part, and the second wire includes the second dense wire part.

7. The strain sensor according to claim 3, wherein:
the first wire includes a first extending part, a second extending part, and a first folded part that connects end portions of the first extending part and the second extending part to each other;
each of the first extending part and the second extending part extends over the first region, the sensing region, and the second region;
the first folded part is disposed in the first region or the second region;
the second wire includes a third extending part, a fourth extending part, and a second folded part that connects end portions of the third extending part and the fourth extending part to each other;
each of the third extending part and the fourth extending part extends over the first region, the sensing region, and the second region;
the second folded part is disposed in the first region or the second region; and
in the sensing region, the first extending part and the second extending part are arranged at a first interval in the second direction, the third extending part and the fourth extending part are arranged at a second interval in the second direction, and the first interval and the second interval are less than the distance between the first wire and the second wire in the second direction.

8. The strain sensor according to claim 7, wherein, in the plan view from the normal direction of the major surface, one of the first extending part and the second extending part that is closer to the second wire includes the first dense wire part and the second dense wire part.

9. The strain sensor according to claim 7, wherein, in the plan view from the normal direction of the major surface, one of the first extending part and the second extending part that is closer to the second wire includes the first dense wire part, and one of the third extending part and the fourth extending part that is closer to the first wire includes the second dense wire part.

10. The strain sensor according to claim 4, wherein, in the plan view from the normal direction of the major surface, an area of the first dense wire part and an area of the second dense wire part are different from each other.

11. The strain sensor according to claim 3, wherein, in the plan view from the normal direction of the major surface, one of the first dense wire part and the second dense wire part has a meander shape or a double winding shape.

12. The strain sensor according to claim 1, wherein a thickness of the strain sensor through the first region in the normal direction of the major surface and a thickness of the strain sensor through the second region in the normal direction of the major surface are greater than a thickness of the strain sensor through the sensing region in the normal direction of the major surface.

13. The strain sensor according to claim 1, further comprising:
a first upper layer disposed on the first region of the substrate to cover the first wire and the second wire; and
a second upper layer disposed on the second region of the substrate to cover the first wire and the second wire.

14. The strain sensor according to claim 13, further comprising:
a third upper layer disposed on the sensing region of the substrate to cover the first wire and the second wire,
wherein materials of each of the first upper layer and the second upper layer are harder than a material of the third upper layer.

15. The strain sensor according to claim 3, wherein:
each of the first wire and the second wire includes the first dense wire part and the second dense wire part; and
in the plan view from the normal direction of the major surface, an area of the first dense wire part of the first wire is greater than an area of the first dense wire part of the second wire, and an area of the second dense wire part of the first wire is greater than an area of the second dense wire part of the second wire.

16. The strain sensor according to claim 3, further comprising:
a third wire and a fourth wire that are disposed on or in the major surface of the substrate,
wherein:
the third wire and the fourth wire extend over the first region, the sensing region, and the second region;
the first wire, the second wire, the third wire, and the fourth wire are electrically isolated from each other;
in the plan view from the normal direction of the major surface, the sensing region has an upper-end portion and a lower-end portion that face each other in the second direction, and in the sensing region, the first wire, the second wire, the third wire, and the fourth wire are arranged in this order from the lower-end portion toward the upper-end portion;
one of the third wire and the fourth wire includes a third dense wire part that is disposed in the first region and in which a corresponding one of the third wire and the fourth wire is laid out more densely than in the sensing region; and
in the plan view from the normal direction of the major surface, the third dense wire part is located closer to the upper-end portion than the first dense wire part, and an area of the first dense wire part and an area of the third dense wire part are different from each other.

17. The strain sensor according to claim 16, wherein:
one of the third wire and the fourth wire includes a fourth dense wire part that is disposed in the second region and in which a corresponding one of the third wire and the fourth wire is laid out more densely than in the sensing region; and
in the plan view from the normal direction of the major surface, the fourth dense wire part is located closer to the upper-end portion than the second dense wire part, the area of the first dense wire part is greater than the area of the third dense wire part, and an area of the second dense wire part is greater than an area of the fourth dense wire part.

18. The strain sensor according to claim 1, wherein each of the first wire and the second wire extends in the first direction in the sensing region.

19. A strain sensor comprising:
a substrate that includes a major surface and that is configured to be stretchable and contractible; and
a first wire and a second wire disposed on or in the major surface,
wherein, in a plan view from a normal direction of the major surface, the substrate includes a sensing region configured to be stretchable and contractible in a first direction, and a first region and a second region that face each other in the first direction across the sensing region;
wherein at least one of the first wire and the second wire includes a first dense wire part that is disposed in the first region and in which a corresponding one of the first wire and the second wire is laid out more densely than in the sensing region; and
wherein at least one of the first wire and the second wire includes a second dense wire part that is disposed in the second region and in which a corresponding one of the first wire and the second wire is laid out more densely than in the sensing region.

20. The strain sensor according to claim 19,
wherein the first wire and the second wire extend over the first region, the sensing region, and the second region; and
wherein the first wire and the second wire are electrically isolated from each other and are arranged in the sensing region at a distance from each other in a second direction that is orthogonal to the first direction.
